(19) United States
(12) Patent Application Publication
(10) Pub. No.: US 2012/0211534 A1
(43) Pub. Date: Aug. 23, 2012

(54) WHEEL-MOUNTED GOLF SCORECARD HOLDER WITH PENCIL SHARPENER

(76) Inventor: Frank Hake, Bonita Springs, FL (US)

(21) Appl. No.: 13/030,222

(22) Filed: Feb. 18, 2011

(51) Int. Cl. B60R 7/00

(52) U.S. Cl. 224/276

(57) ABSTRACT

A scorecard holder (1) that is mountable to a steering wheel (19) of a golf cart. Said scorecard holder (1) having a clip (3) and a board portion (4) that provides a flat surface upon which to write. A pencil sharpener (2) may be integrated into the scorecard holder or removably attachable to the scorecard holder by placing the pencil sharpener in a recessed area 11 or other holder located in the clip or on the board portion.

### BACKGROUND OF THE INVENTION

This invention relates to golf score keeping accessories and more particularly, a wheel mounted scorecard holder assembly having a pencil sharpener located thereon.

When a golfer is out on a golf course and keeping score on a scorecard, the presence of a pencil is necessary for doing so. Scorecard holders are typically mounted on the steering wheels of golf carts to provide a flat surface for writing on the scorecards. Golfers commonly use small pencils provided for free by the golf course to write on the scorecards. However while on out on a golf course, golfers do not have a means to sharpen a pencil when it becomes dull or the tip of the pencil breaks. As a result, many golfers carry multiple pencils and simply throw pencils away as each one becomes dull or breaks, which is a wasteful practice.

Therefore, a need exists for a wheel-mounted scorecard holder having a pencil sharpener located thereon for sharpening pencils while on a golf course.

The relevant prior art includes the following references:

| Patent/Ser. No. | | Issue/ |
|---|---|---|
| U.S. Patent Documents | Inventor | Publication Date |
| 5,083,736 | McCoy | Jan. 28, 1992 |
| 4,763,415 | Huang | Aug. 16, 1988 |
| 4,741,105 | Wong | May 03, 1988 |
| 4,593,468 | Vincent | Jun. 10, 1986 |
| 4,166,559 | Richardson | Sep. 04, 1979 |
| 3,128,021 | Habbena | Sep. 22, 1960 |
| 2,506,918 | Brown | May 23, 1946 |
| 2,150,709 | Bake | Mar. 14, 1939 |
| 2,132,121 | Nudelman | Oct. 04, 1938 |
| 2,069,619 | Mendelson | Feb. 02, 1937 |
| 1,558,818 | Kumagi | Oct. 27, 1925 |
| 1,347,222 | Hufschmidt | Jul. 20, 1920 |
| 1,214,996 | Boye | Feb. 06, 1917 |
| 759,499 | Brandes | May 10, 1904 |

### SUMMARY OF THE INVENTION

The primary object of the present invention is to provide a scorecard holder having a pencil sharpener located thereon that allows a golfer to sharpen pencils while on a golf course.

A further object of the present invention is to provide a scorecard holder having a pencil sharpener that may be easily replaced when the blade in the pencil sharpener becomes dull.

An additional object of the present invention is to provide a scorecard holder having a pencil sharpener located on the clip portion of a clipboard, thereby allowing the clip portion to be integrated into new scorecard holders or existing scorecard holders to be retrofitted by replacing the existing clip.

The present invention fulfills the above and other objects by providing a scorecard holder that is mountable to a steering wheel of a golf cart. The scorecard holder comprises a clip and a board portion that provides a flat surface upon which to write. The board portion has a top surface and a bottom surface. A pencil sharpener may be integrated into the scorecard holder or removably attachable to the scorecard holder by placing the pencil sharpener in a recessed slot or other holder located in the clip or on the board portion.

The above and other objects, features and advantages of the present invention should become even more readily apparent to those skilled in the art upon a reading of the following detailed description in conjunction with the drawings wherein there is shown and described illustrative embodiments of the invention.

### BRIEF DESCRIPTION OF THE DRAWINGS

In the following detailed description, reference will be made to the attached drawings in which:

FIG. 1 is an exploded top perspective view of a scorecard holder of the present invention having a pencil sharpener located in a clip illustrating the assembly of the scorecard holder;

FIG. 2 is a cross-section view along line 2-2 of FIG. 1 of a scorecard holder of the present invention having a pencil sharpener located in a clip;

FIG. 3 is a top perspective view of a scorecard holder of the present invention having a pencil sharpener integrated into a clip;

FIG. 4 is a bottom view of a scorecard holder of the present invention having a pencil sharpener located in a board portion of the scorecard holder;

FIG. 5 is a cross-section view along line 5-5 of FIG. 4 of a scorecard holder of the present invention having a pencil sharpener located on a board portion of the scorecard holder;

FIG. 6 is a top perspective view of a scorecard holder of the present invention having a pencil sharpener integrated into the board portion of the scorecard holder;

FIG. 7 is a top perspective view of a scorecard holder of the present invention having a pencil sharpener integrated vertically into the board portion of the scorecard holder; and

FIG. 8 is a top perspective view of a scorecard holder of the present invention having a pencil sharpener integrated vertically into the clip of the scorecard holder.

### DESCRIPTION OF THE PREFERRED EMBODIMENTS

For purposes of describing the preferred embodiment, the terminology used in reference to the numbered components in the drawings is as follows:

| | |
|---|---|
| 1. | scorecard holder |
| 2. | pencil sharpener |
| 3. | clip |
| 4. | board portion |
| 5. | attachment means |
| 6. | screw |
| 7. | post |
| 8. | aperture |
| 9. | spring |
| 10. | lower edge of clip |
| 11. | holding means |
| 12. | recessed area |
| 13. | body |
| 14. | conical hole |
| 15. | blade |
| 16. | slot |
| 17. | mounting means |
| 18. | clip |
| 19. | steering wheel |
| 20. | top surface of board portion |
| 21. | bottom surface of board portion |

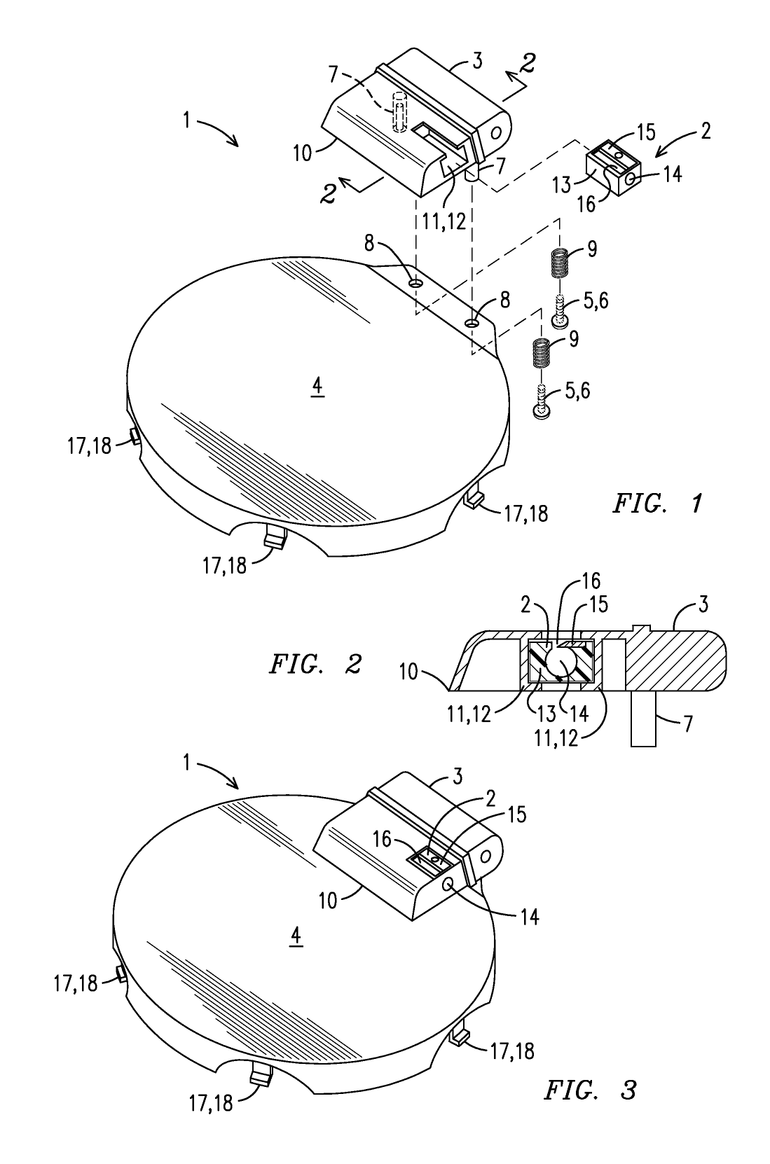

With reference to FIGS. 1 and 2, an exploded top perspective view of a scorecard holder 1 of the present invention having a pencil sharpener 2 located in a clip 3 illustrating the assembly of the scorecard holder 1 and a cross-section view along line 2-2 of FIG. 1 of a scorecard holder 1 of the present invention having a pencil sharpener 2 located in a clip 3, respectively, are shown. The scorecard holder 1 comprises a clip 3 and a board portion 4 that provides a flat surface upon which to write. The clip 3 is attached to the board portion 4 via an attachment means 5, such as screw 6, nut, bolt, rivets, etc., in a manner that allows the clip 3 to exert constant pressure on the board portion 4 in order to hold a scorecard in place on the board portion 4. Posts 7 extend downward from the clip 3 and are placed through corresponding apertures 8 located on the board portion 4, as illustrated in FIG. 1. Springs 9 are then placed over the posts 7 and are held in place by screws 6 that are inserted into the posts 7. The springs 9 provide upward pressure on the posts 7, thereby ensuring that a lower edge 10 of the clip 3 exerts constant pressure on the board portion 4. A holding means 11, such as a recessed area 12, located in the clip 3 holds a pencil sharpener 2 in the clip 3. The pencil sharpener 2 is preferably a prism pencil sharpener having a body 13, a conical hole 14 extending into the body 13, a blade 15 for sharpening a pencil and a slot 16 that exposes the conical hole 14 to the blade 15. At least one mounting means 17, such as clips 18, screws, clamps, nuts, bolts, etc., is located on the board portion for mounting the scorecard holder 1 to a steering wheel 19 of a golf cart, as shown in FIG. 6.

With reference to FIG. 3, a top perspective view of a scorecard holder 1 of the present invention having a pencil sharpener 2 integrated into a clip 3 is shown. The scorecard holder 1 comprises a clip 3 and a board portion 4 that provides a flat surface upon which to write. The clip 3 is attached to the board portion 4 via an attachment means 5, as shown in FIG. 1, in a manner that allows the clip 3 to exert constant pressure on the board portion 4 in order to hold a scorecard in place on the board portion 4. A pencil sharpener 2 is integrated into the clip 3. The pencil sharpener 3 comprises a conical hole 14 extending into the side of the clip 3, a blade 15 for sharpening a pencil and a slot 16 that exposes the conical hole 14 to the blade 15. Locating the pencil sharpener 2 in the clip 3 allows a user to retrofit an existing scorecard holder 1 simply by replacing an existing clip with a clip 3 of the present invention. At least one mounting means 17, such as clips 18, screws, clamps, nuts, bolts, etc., is located on the board portion for mounting the scorecard holder 1 to a steering wheel 19 of a golf cart, as shown in FIG. 6.

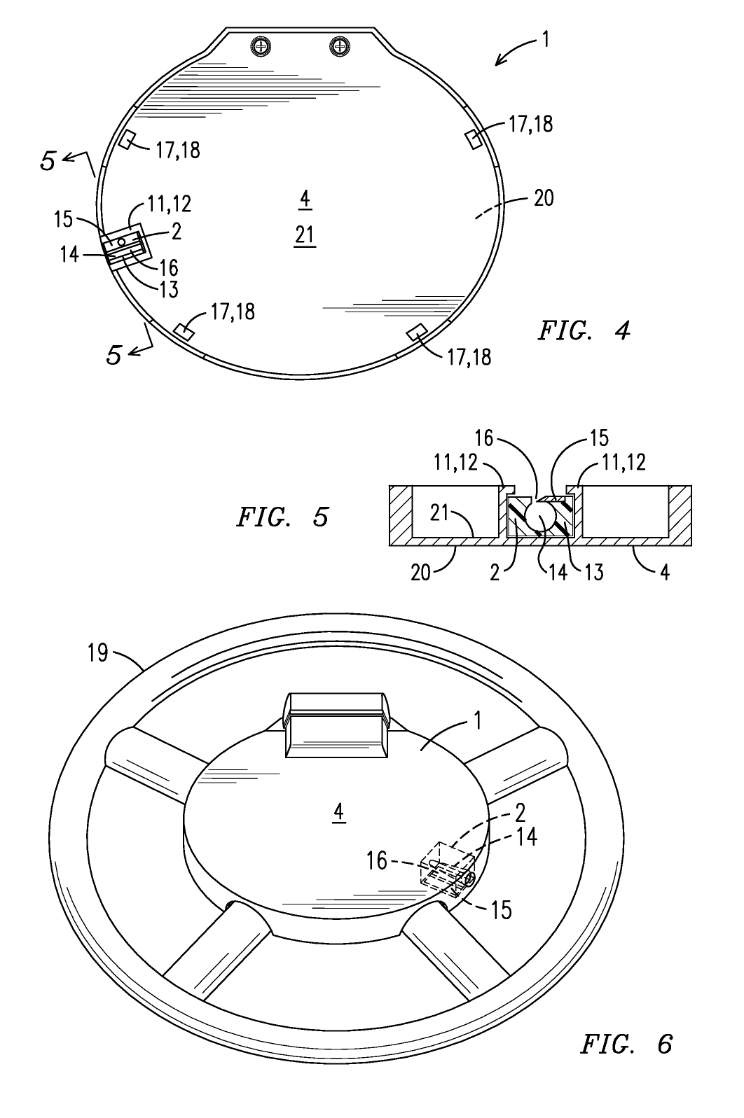

With reference to FIGS. 4 and 5, a bottom view of a scorecard holder 1 of the present invention having a pencil sharpener 2 located on a board portion 4 of the scorecard holder 1 and a cross-section view along line 5-5 of FIG. 4 of a scorecard holder 1 of the present invention having a pencil sharpener 2 located on a board portion 4 of the scorecard holder 1, respectively, are shown. The scorecard holder 1 comprises a clip 3 and a board portion 4 having a top surface 20 and a bottom surface 21. A holding means 11, such as a recessed area 12, holds a pencil sharpener 2 in on the bottom surface 18 of the board portion 4. The pencil sharpener 2 is preferably a prism pencil sharpener having a body 13, a conical hole 14 extending into the body 13, a blade 15 for sharpening a pencil and a slot 16 that exposes the conical hole 14 to the blade 15. At least one mounting means 17, such as clips 18, screws, clamps, nuts, bolts, etc., is located on the board portion for mounting the scorecard holder 1 to a steering wheel 19 of a golf cart, as shown in FIG. 6.

With reference to FIG. 6, a top perspective view of a scorecard holder 1 of the present invention having a pencil sharpener 2 integrated into the board portion 4 of the scorecard holder 1 is shown. The pencil sharpener 2 comprises a conical hole 14 extending into the side of the board portion 4, a blade 15 for sharpening a pencil and a slot 16 that exposes the conical hole 14 to the blade 15. At least one mounting means 17, such as clips 18, screws, clamps, nuts, bolts, etc., (as shown in FIGS. 1-5) is located on the board portion for mounting the scorecard holder 1 to a steering wheel 19 of a golf cart.

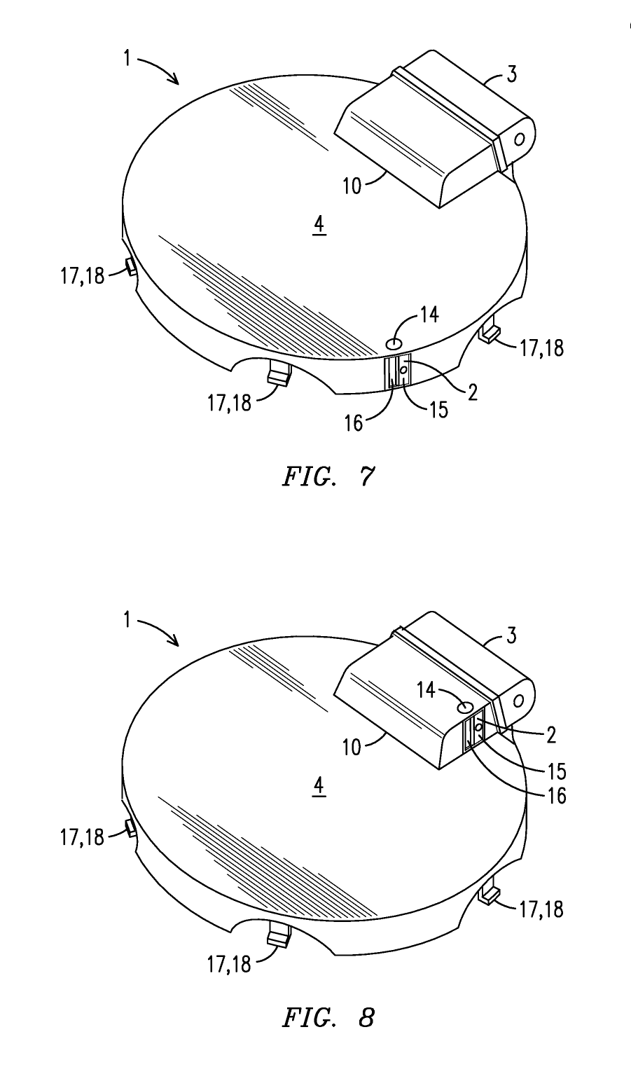

With reference to FIG. 7, a top perspective view of a scorecard holder 1 of the present invention having a pencil sharpener 2 vertically integrated into the board portion 4 of the scorecard holder 1 is shown. The pencil sharpener 2 comprises a conical hole 14 extending into the side of the board portion 4, a blade 15 for sharpening a pencil and a slot 16 that exposes the conical hole 14 to the blade 15.

Finally with reference to FIG. 8, a top perspective view of a scorecard holder 1 of the present invention having a pencil sharpener 2 vertically integrated into the clip 3 of the scorecard holder 1 is shown. The pencil sharpener 2 comprises a conical hole 14 extending into the side of the clip 3, a blade 15 for sharpening a pencil and a slot 16 that exposes the conical hole 14 to the blade 15.

It is to be understood that while a preferred embodiment of the invention is illustrated, it is not to be limited to the specific form or arrangement of parts herein described and shown. It will be apparent to those skilled in the art that various changes may be made without departing from the scope of the invention and the invention is not to be considered limited to what is shown and described in the specification and drawings.

Having thus described my invention, I claim:

1. A scorecard holder comprising:
a board portion having a bottom surface and a top surface for providing a flat surface upon which to write;
a clip attached to the board portion via an attachment means in a manner that allows the clip to exert constant pressure on the board portion in order to hold a scorecard in place on the board portion; and
a pencil sharpener located on the scorecard holder.

2. The scorecard holder of claim 1 further comprising:
a mounting means located on the board portion for mounting the scorecard holder to a steering wheel.

3. The scorecard holder of claim 1 wherein the pencil sharpener further comprises:
a body having a conical hole, a blade and a slot exposing the blade to the conical hole.

4. The scorecard holder of claim 1 wherein:
said pencil sharpener is located on the clip of the scorecard holder.

5. The scorecard holder of claim 4 wherein:
said pencil sharpener is removably held in a holding means located on the clip.

6. The scorecard holder of claim 5 wherein:
said holding means is a recessed area.

7. The scorecard holder of claim 1 wherein:
said pencil sharpener is located on the board portion of the scorecard holder.

8. The scorecard holder of claim 7 wherein:
said pencil sharpener is removably held in a holding means located on the board portion.

9. The scorecard holder of claim 8 wherein:
said holding means is a recessed area.

10. A scorecard holder comprising:
a board portion having a bottom surface and a top surface for providing a flat surface upon which to write;
a clip attached to the board portion via an attachment means in a manner that allows the clip to exert constant pressure on the board portion in order to hold a scorecard in place on the board portion;
a pencil sharpener located on the scorecard holder; and
a mounting means located on the board portion for mounting the scorecard holder to a steering wheel.

11. The scorecard holder of claim 10 wherein the pencil sharpener further comprises:
a body having a conical hole, a blade and a slot exposing the blade to the conical hole.

12. The scorecard holder of claim 10 wherein:
said pencil sharpener is located on the clip of the scorecard holder.

13. The scorecard holder of claim 12 wherein:
said pencil sharpener is removably held in a holding means located on the clip.

14. The scorecard holder of claim 13 wherein:
said holding means is a recessed area.

15. The scorecard holder of claim 10 wherein:
said pencil sharpener is located on the board portion of the scorecard holder.

16. The scorecard holder of claim 15 wherein:
said pencil sharpener is removably held in a holding means located on the board portion.

17. The scorecard holder of claim 16 wherein:
said holding means is a recessed area.

18. A scorecard holder comprising:
a board portion having a bottom surface and a top surface for providing a flat surface upon which to write;
a clip attached to the board portion via an attachment means in a manner that allows the clip to exert constant pressure on the board portion in order to hold a scorecard in place on the board portion;
a pencil sharpener located on the scorecard holder;
said pencil sharpener having a body having a conical hole, a blade and a slot exposing the blade to the conical hole; and
a mounting means located on the board portion for mounting the scorecard holder to a steering wheel.

19. The scorecard holder of claim 18 wherein:
said pencil sharpener is located on the clip of the scorecard holder.

20. The scorecard holder of claim 19 wherein:
said pencil sharpener is removably held in a holding means located on the clip.

21. The scorecard holder of claim 20 wherein:
said holding means is a recessed area.

22. The scorecard holder of claim 18 wherein:
said pencil sharpener is located on the board portion of the scorecard holder.

23. The scorecard holder of claim 22 wherein:
said pencil sharpener is removably held in a holding means located on the board portion.

24. The scorecard holder of claim 23 wherein:
said holding means is a recessed area.
